(19) United States
(12) Patent Application Publication
(10) Pub. No.: US 2002/0005261 A1
(43) Pub. Date: Jan. 17, 2002

(54) Corner for screen

(76) Inventor: Gerard Therrien, Saint-Nicolas (CA)

Correspondence Address: Eric Fincham, 316 Knowlton Road, Lac Brome, QC, J0E 1V0, CA

(21) Appl. No.: 09/843,654

(22) Filed: Apr. 26, 2001

Related U.S. Application Data
(60) Provisional application No. 60/200,136, filed on Apr. 27, 2000.

(51) Int. Cl. E06B 3/30

(52) U.S. Cl. 160/381

(57) ABSTRACT

A corner member for securing together the structural members forming the periphery of a screen, the corner members having a protrusion for locking the screen in place in a window to obviate the need for a separate locking device. The corner members may be formed of any color and are preferably of a plastic material which has been injection molded.

### FIELD OF THE INVENTION

The present invention relates to windows and more particularly, relates to screening used for windows.

### BACKGROUND OF THE INVENTION

In modern day windows, a screen is usually provided as a part of the original window. The screen member must be lightweight and easily removable such that access may be had to the glass portion of the window. Traditionally, the screen member is formed by frame members along the top, bottom and sides, the frame members being joined together at the corners by suitable means. The joining at the corners may conveniently accomplished by means of a screen corner member.

A number of different types of corner members are known in the art. While they all perform the same function of attaching the frame members together, they do so in many different fashions.

### SUMMARY OF THE INVENTION

It is an object of the present invention to provide a novel screen corner member which can attach the structural components together and which also includes means for locking the screen in place.

According to one aspect of the present invention, there is provided a corner member suitable for connecting two screening members together, the corner member comprising a corner portion having a front face and a rear face, first and second exterior side walls extending between the front and rear faces, first and second legs extending outwardly from the corner portion, the first and second legs being mutually perpendicular, a lip extending outwardly from the corner portion, and a protrusion extending outwardly from one of said exterior side walls.

The corner member of the present invention, although it can be formed of many different materials, is preferably formed of an injection molded plastic material. As such, it can be fabricated any desired colour.

As aforementioned, the corner member has a corner portion with a front and rear face, and with first and second exterior side walls extending therebetween. A protrusion is mounted on one of the side walls for locking the screen in place. Normally, the protrusion would be placed on the exterior side wall which ends either in the top facing direction or the bottom facing direction or both. In other words, the protrusion will be formed on only one of the side walls extending between the front and rear faces of the corner portion.

Also, the corner member includes a lip which extends outwardly from the corner portion in the form of a flange. The lip or flange may extend as a portion of the rear face or alternatively, it may be offset with respect to the rear face. The particular design will vary depending upon the design of the window unit for receiving the screen.

The protrusion may be of any desired configuration and conventionally, may be formed either in a semi-circular configuration, a rectangular or triangular configuration.

### BRIEF DESCRIPTION OF THE DRAWINGS

Having thus generally described the invention, reference will be made to the accompanying drawings illustrating an embodiment thereof, in which:

FIG. 1a is a perspective view of a corner member according to an embodiment of the present invention;

FIG. 1b is a perspective view from the opposite side thereof;

FIG. 2 is a side elevational view thereof;

FIG. 3 is a top plan view thereof;

FIG. 4 is a an end elevational view thereof;

FIG. 5 is a side elevational view with the member rotated 90° from that shown in FIG. 2;

FIG. 6 is a end elevational view;

FIG. 7 is a top plan view;

FIG. 8 is a sectional view taken along the lines 8-8 of FIG. 6;

FIG. 9 is a cross sectional view taken along the lines 9-9 of FIG. 6;

FIG. 10 is a cross sectional view of a spring member.

FIG. 11 is a partial cross sectional configuration illustrating an offset lip arrangement; and

FIGS. 12a to 12c illustrate different configurations of the protrusions.

### DESCRIPTION OF THE PREFERRED EMBODIMENTS

Referring to the drawings in greater detail and by reference characters thereto, there is illustrated a corner member generally designated by reference numeral 10 and which corner member 10 is suitable for use in connecting a pair of channel members together.

Corner member 10 includes an upper leg 12 and a lower leg 14. It will be understood that the terms “upper” and “lower” are used merely for purposes of description and that the piece will have many different orientations depending upon the placement thereof.

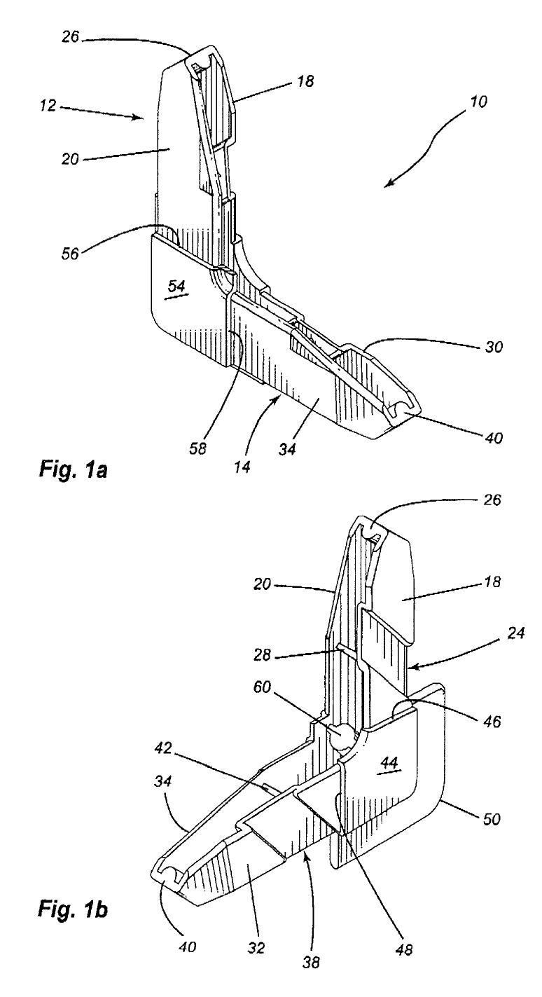

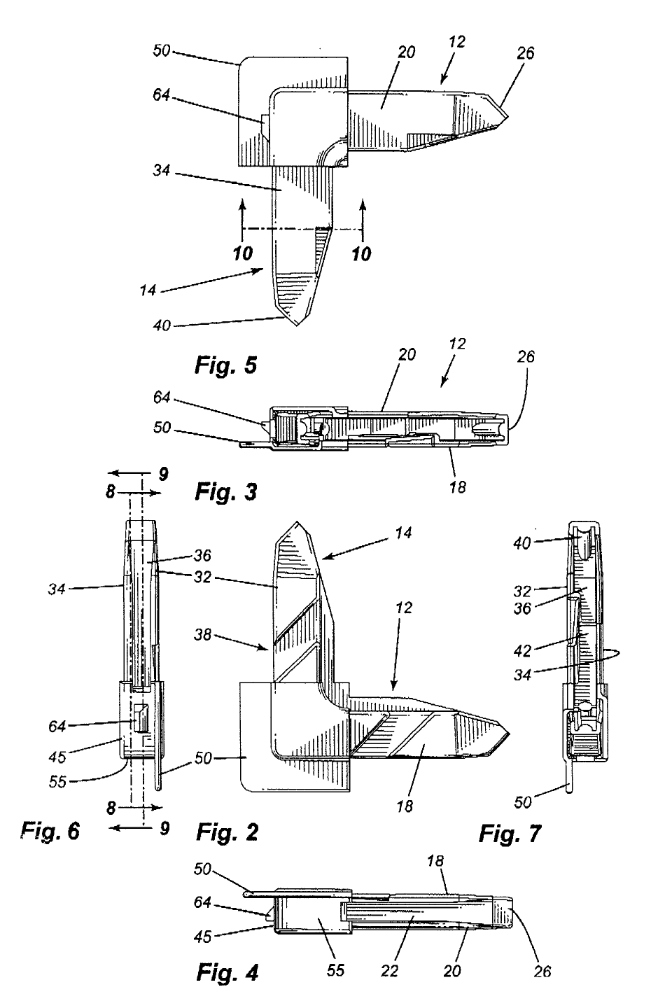

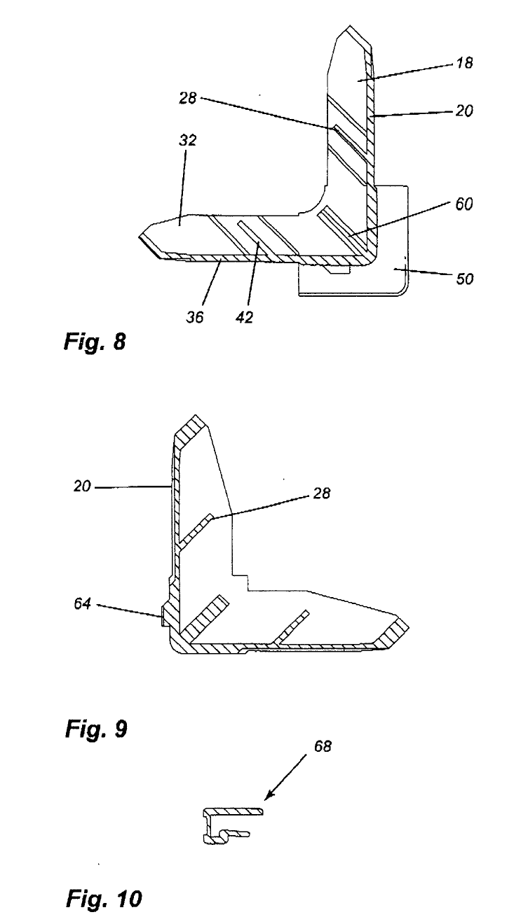

Upper leg 12 includes an upper leg inner side wall 18 and an upper leg outer side wall 20 having an upper leg back wall extending therebetween. As may be seen in FIG. 1b and FIG. 2, a diagonally extending recess 24 is formed in upper leg inside wall 18. At their distal ends, upper leg inside wall 18, upper leg outer side wall 20 along with upper leg back wall 22 form an inwardly extending portion generally designated by reference numeral 26. A reinforcing rib 28 extends from upper leg back wall 22 and between upper leg inner side wall 18 and upper leg outer side wall 20.

Similarly, lower leg 14 includes a lower leg inner side wall 32, and a lower leg outer side wall 34 and a lower leg back wall 36 extending therebetween. A recess 38, which recess 38 extends diagonally, is formed in lower leg inner side wall 32. As was noted with respect to upper leg 12, lower leg 14 also includes an inwardly extending portion 40 at the distal ends of walls 32, 34 and 36. A rib 42 is also formed between the walls.

Between upper leg 12 and outer leg 14 and in particular, between inner side wall 18 and inner side wall 22, there is provided a corner portion having a rear face 44 and a front face 54. Rear face 44 has an upper abutment surface 46 and a lower abutment surface 48 which are designed to abut against the end walls of a channel containing the screening. It will be noted that there is provided a lip 50 extending from rear face 44. Similarly, front face 54 has an upper abutment surface 56 and a lower abutment surface 58.

Extending between rear face 44 and front face 54 is an inner central reinforcing rib generally designated by reference numeral 60 and first and second exterior walls 45 and 55.

The corner 10 also includes a locking protrusion 64 which extends downwardly from side wall 45 and is designed to lock in the channel of a frame for receiving the screen. There is also provided a spring member 68 which is designed to fit within a recess (not shown) in the back wall and exert a biasing force on the finished screen to retain the same in position and to maintain locking protrusion 64 in the desired position and prevent the screen from falling out of the frame.

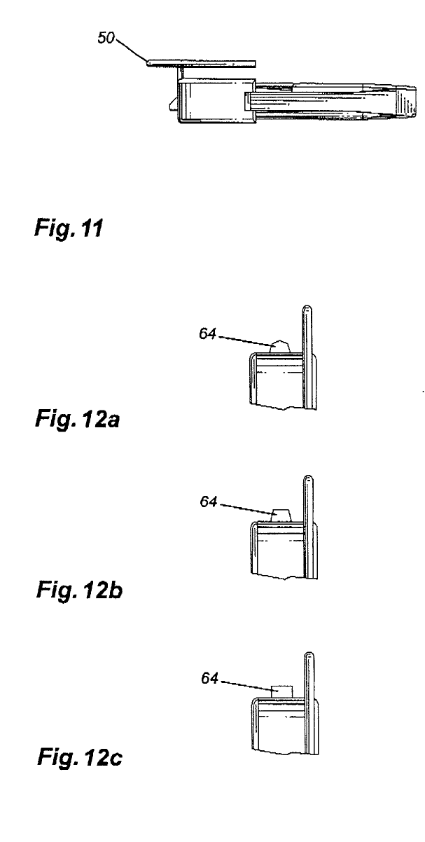

As seen in the embodiment of FIG. 11, lip 50′ may be offset with respect to rear face 44′.

In FIGS. 12a, 12b and 12c, various configurations of locking protrusion 64 are shown.

It will be understood that the above described embodiment is for purposes of illustration only and that changes and modifications may be made thereto without departing from the spirit and scope of the invention.

I claim:

1. A corner member suitable for connecting two screening members together, said corner member comprising:
a corner portion having a front face and a rear face, first and second exterior side walls extending between said front and rear faces;
first and second legs extending outwardly from said corner portion, said first and second legs being mutually perpendicular;
a lip extending outwardly from said corner portion; and
a protrusion extending outwardly from one of said exterior side walls.

2. The corner member of claim 1 wherein said lip forms a continuation of said rear face.

3. The corner member of claim 1 wherein said lip is co-planer with said rear face and extends outwardly from an extended portion of said first and second side walls.

4. The corner member of claim 1 wherein said protrusion has a substantially triangular configuration.

5. The corner member of claim 4 wherein said protrusion has an overall right angle configuration.

6. The corner member of claim 1 wherein said protrusion has a generally rectangular configuration.

7. The corner member of claim 1 wherein each of said first and second legs has a front face and a rear face and a side wall extending therebetween.

8. The corner member of claim 7 further including a channel formed in said rear face of each of said first and second legs.

9. The corner member of claim 7 further including at least one reinforcing rib extending between said front and rear faces.

10. The corner member of claim 7 wherein a distal end of said first and second legs has a tapered configuration.
